(19) United States
(12) Patent Application Publication
(10) Pub. No.: US 2005/0080921 A1
(43) Pub. Date: Apr. 14, 2005

(54) Method of implementing handshaking between 802.1X-based network access device and client

(76) Inventor: Ruixin Lu, Guangdon Province (CN)

Correspondence Address: FISH & RICHARDSON P.C., 5000 BANK ONE CENTER, 1717 MAIN STREET, DALLAS, TX, 75201, US

(21) Appl. No.: 10/942,306

(22) Filed: Sep. 16, 2004

Related U.S. Application Data
(63) Continuation of application No. PCT/CN03/00203, filed on Mar. 19, 2003.

(30) Foreign Application Priority Data
Mar. 26, 2002 (CN) 02116339.1

(51) Int. Cl. G06F 15/16

(52) U.S. Cl. 709/237

(57) ABSTRACT

A method of implementing handshaking between a network access device and a client includes sending an authentication request message containing the client's address and an appointed multicasting address. The authentication request message is sent from the client to the network access device to authenticate the client. After a successful authentication, the network access device sends handshaking messages at a preset handshaking time interval. When the client receives the handshaking messages, the client sends handshaking response messages to the network access device, also at the preset handshaking time interval. The handshaking messages are an EAP-Request/Identity messages defined in 802.1X, and the handshaking response messages are EAP-Response messages defined in 802.1X. If the network access device or the client does not receive messages from its counterpart for specified times within the handshaking time interval, they perform processing to take the client off line and sending a prompt for reconnection, respectively.

### CROSS-REFERENCE TO RELATED APPLICATIONS

Under 35 USC § 120, this application is a continuation application of international application serial number PCT/CN03/00203, filed Mar. 19, 2003, which claims priority from China application serial number 02116339.1, filed Mar. 26, 2002, both of which are incorporated by reference.

### FIELD OF THE INVENTION

The present invention relates to handshaking between a network access device and a client, particularly to implementing handshaking between a network access device and a client in an 802.1X-based broadband access network.

### BACKGROUND OF THE INVENTION

In conventional broadband access networks, network access control for a client is usually accomplished on the basis of a port-based network access control protocol (i.e., 802.1X). During the access process, authentication and control for the client is performed at the physical access level of network devices, i.e., at ports of an Ethernet switch or a broadband access device. If a client connected to such a port passes authentication successfully, it can access resources in the network; otherwise, it is denied access to the resources. The hierarchy of 802.1X, shown in FIG. 2, comprises 3 parts: the client part, the network access device part, and the authentication server part. The device in the user access layer should implement the Authenticator role in the 802.1X mechanism. The client part is usually installed in the subscriber's PC; the authentication server part is usually installed in the operator's AAA (Accounting/Authentication/Authorization) center. EAPOL (Extensible Authentication Protocol Over LAN) defined in 802.1X runs between the client and the network access device, while EAP (Extensible Authentication Protocol) runs between the network access device and the authentication server. The network access device has a controlled port and an uncontrolled port, wherein the uncontrolled port is always in a bidirectional connected state and is mainly used to transmit EAPOL frames to ensure the client can always send or accept EAP messages for authentication. The controlled port is opened only when the client passes the authentication and is mainly used to transmit network resources and services. The controlled port may be configured as a “bidirectionally controlled” or “only input controlled” port to adapt to different application environments.

As described above, 802.1X-based network access only supports re-authentication of the client, which results in severe defects in an operator's network: first, because time duration in the operator's network is calculated according to the time span from successful subscriber authentication to subscriber logoff, abnormal shutdown or any operational abnormality of the client will cause the client to be unable to send a logoff message, resulting in accounting errors for charges based on time duration because of the abnormalities of the client. Second, fraud on the client may occur, e.g., if a client is shut down directly without logoff after passing authentication, another client may replace the client to access the network directly. Third, network malfunctions will not be communicated to the subscriber in the event of an access device malfunction.

### SUMMARY OF THE INVENTION

By implementing handshaking between an 802.1X-based network access device and a client, it is possible to solve accounting and security problems of an 802.1X-based network effectively.

A method of implementing handshaking between an 802.iX-based network access device and a client includes:

(1) the client sending an authentication request message containing the client's address and an appointed multicasting address to the network access device; and

(2) the network access device recording the client's address according to the authentication request message, and sending handshaking messages to the client at a time interval of handshaking after the client passes the authentication successfully, and the client sending handshaking response messages to the network access device in response to receiving the handshaking messages.

The handshaking messages sent from the network access device to the client are EAP-Request/Identity messages or ARP-Request (ARP, Address Resolve Protocol) messages defined in 802.1X.

The handshaking response messages sent from the client to the network access device are EAP-Response/Identity messages or ARP-Response messages defined in 802.1X.

In some implementations, after the client passes authentication successfully, if handshaking response messages are not received from the client for a specified number of times at the time interval of handshaking, the network access device will make the subscriber off line.

After the client passes authentication successfully, if handshaking messages are not received from the network access device for a specified number of times at the time interval of handshaking, the client will send a prompt to the subscriber for reconnection.

According to the present invention, the network access device authenticates the client according to the authentication request message containing the client's address and the access device's address sent from the client, and the network access device sends handshaking messages to the client at the time interval of handshaking after the client passes the authentication successfully. The client sends handshaking response messages to the network access device when it receives the handshaking messages. The messages are EAP-Request/Identity messages and EAP-Response/Identity messages defined in 802.1X, or ARP-Request messages or ARP-Response messages defined in 802.1X. Thus, the present invention extends the handshaking mechanism while still supporting standard 802.1X clients, e.g., Windows XP, avoiding difficulties and costs caused by frequent changes of client software. In case there is any abnormality at the client, e.g., system halt, power down, or abnormal shutdown, the access device can detect the abnormality in time, so that accounting can be stopped accordingly, avoiding accounting disputes. In addition, because of the long original time interval of re-authentication defined in the 802.1X hierarchy, another client may impersonate the authenticated client within the time interval, so in order to prevent an impersonation of the authenticated client, the time interval of re-authentication has to be shortened as much as possible, e.g., second level. However, numerous authentication messages will flood the authentication server when there are a large number of clients in the operator's network, causing resource congestion. In contrast, because the EAP handshaking messages utilized in the present invention are identical to the re-authentication initiating messages, the access device can identify whether the messages are for re-authentication or for handshaking according to the state in the state machine, realizing full compatibility with the re-authentication defined in 802.1X; furthermore, handshaking between the network access device and the client can detect any impersonator in time, so that network security is enhanced.

### BRIEF DESCRIPTION OF THE DRAWINGS

FIG. 1 is a flow chart of an embodiment of the method according to the present invention;

FIG. 2 shows the hierarchy of 802.1X protocol.

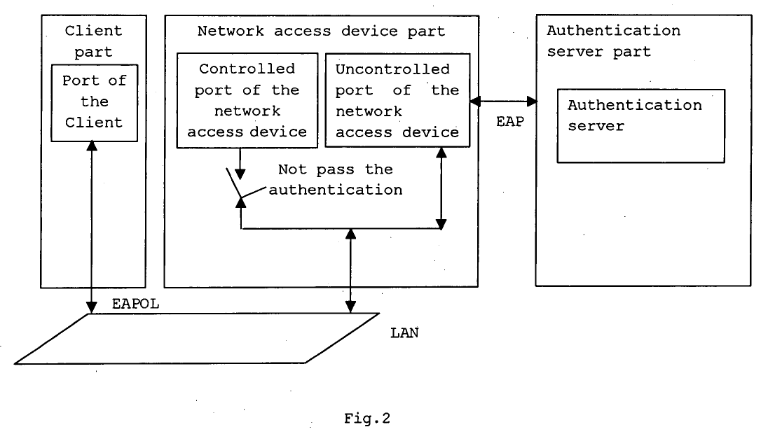

### DETAILED DESCRIPTION OF THE EMBODIMENT

Hereunder the present invention will be described in further detail with reference to one embodiment and the attached drawings.

It is within the scope of the present invention to extend the application of the standard 802.1X protocol. Standard protocol messages are utilized to implement a handshaking mechanism compatible with re-authentication, so that the access device can detect client abnormalities actively and stop accounting automatically; in addition, the physical address of the client can also be recorded and identified to prevent the client from being impersonated.

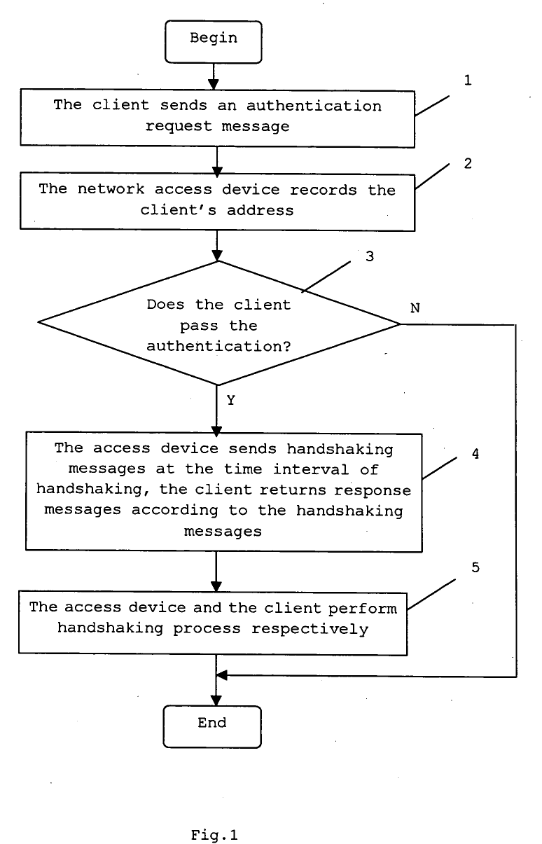

FIG. 1 is a flow chart of an embodiment of the method according to the present invention. Initially, a handshaking time interval is set. When trying to access the network, the client sends an authentication request message containing the client's address and an appointed multicasting address to the network access device in step 1. The authentication request message is an EAPOL message. Then in step 2, the network access device records the client's address according to the authentication request message. At the same time, authentication is performed to the client. Because handshaking between the network access device and the client is applicable only after successful authentication of the client, determining whether the client passes the authentication is performed in step 3. If the client does not pass the authentication, both authentication and handshaking are terminated. Otherwise, in step 4, the access device periodically sends handshaking messages to the client at a preset time interval of handshaking according to the client's address recorded in step 1 in a unicasting mode. When receiving the handshaking messages, the client sends handshaking response messages to the network access device. The handshaking response messages are sent at the preset time interval of handshaking according to the access device's address. The handshaking messages sent from the network access device to the client may be one of the following two types: EAP message and ARP message.

EAP messages sent from the network access device are EAP-Request/Identity messages defined in 802.1X; while the messages that the client returns are EAP-Response/Identity messages defined in 802.1X.

ARP messages sent from the network access device are ARP-Request messages; while the messages that the client returns are ARP-Response messages.

In step 5, the network access device and the client process handshaking respectively. The network access device continues to send handshaking messages at the preset time interval of handshaking. If handshaking response messages are not received from the client for a specified number of times (e.g., 3 times) at the time interval of handshaking, the network access device will deem the client off line and perform relevant processing to take the client offline, and will stop accounting at the same time.

In step 5, the client also continues to send handshaking response messages at the preset time interval of handshaking. If handshaking messages are not received from the network access device for a specified number of times (e.g., 3 times) at the time interval of handshaking (e.g., 5 seconds), the client will deem itself off line and send a prompt to the operator for reconnection.

The network access device used in the process shown in FIG. 1 is a network switch, such as an Ethernet switch.

As shown in FIG. 1, the method of implementing handshaking between the network access device and the client is compatible with the authentication of client. The present invention utilizes the access device's address and the client's address provided in the authentication of the client to perform handshaking between the network access device and the client after successful authentication. Standard messages defined in 802.1X protocol or ARP messages generally supported by clients are utilized during the handshaking process. Therefore, after the network access device implements the handshaking described herein, the client can support it without any modification.

1. A method of implementing handshaking between an 802.1X-based network access device and a client, the method comprising:
the client sending an authentication request message including an address for the client and an appointed multicasting address to the network access device;
the network access device recording the address for the client according to the authentication request message, and sending handshaking messages to the client at a handshaking time interval after the client is authenticated, and the client sending handshaking response messages to the network access device in response to the handshaking messages.

2. The method of claim 1, further comprising setting a handshaking time interval.

3. The method of claim 2, wherein the network access device sending handshaking messages comprises sending handshaking messages to the client in a unicasting mode.

4. The method of claim 3, wherein the handshaking messages sent from the network access device to the client comprise EAP-Request/Identity messages defined in 802.1X.

5. The method of claim 4, wherein the handshaking response messages sent from the client to the network access device comprise EAP-Response/Identity messages defined in 802.1X:

6. The method of claim 5, further comprising: after the client is authenticated, the network access device taking the subscriber off line if handshaking response messages are not received from the client for a specified number of times at the handshaking time interval.

7. The method of claim 6, wherein after the client is authenticated, the client sending a prompt to the network access device for reconnection if handshaking messages are not received from the network access device for a specified number of times at the handshaking time interval.

8. The method of claim 7, wherein the network access device is a network switch.

9. The method of claim 3, wherein the handshaking messages sent from the network access device to the client are ARP-Request messages.

10. The method of claim 9, wherein the handshaking response messages sent from the client to the network access device are ARP-Response messages.

11. The method of claim 3, further comprising: after the client is authenticated, the network access device taking the subscriber off line if handshaking response messages are not received from the client for a specified number of times at the handshaking time interval.

12. The method of claim 3, wherein after the client is authenticated, the client sending a prompt to the network access device for reconnection if handshaking messages are not received from the network access device for a specified number of times at the handshaking time interval.

13. The method of claim 2, wherein the handshaking messages sent from the network access device to the client comprises EAP-Request/Identity messages defined in 802.1X.

14. The method of claim 2, wherein the handshaking messages sent from the network access device to the client are ARP-Request messages.

15. The method of claim 14, wherein the handshaking response messages sent from the client to the network access device are ARP-Response messages.

16. The method of claim 1, wherein the handshaking messages sent from the network access device to the client comprises EAP-Request/identity messages defined in 802.1X.

17. The method of claim 1, wherein the handshaking messages sent from the network access device to the client are ARP-Request messages.

18. The method of claim 17, wherein the handshaking response messages sent from the client to the network access device are ARP-Response messages.

19. The method of claim 1, further comprising: after the client is authenticated, the network access device taking the subscriber off line if handshaking response messages are not received from the client for a specified number of times at the handshaking time interval.

20. The method of claim 1, wherein after the client is authenticated, the client sending a prompt to the network access device for reconnection if handshaking messages are not received from the network access device for a specified number of times at the handshaking time interval.
